(19) United States
(12) Patent Application Publication
(10) Pub. No.: US 2021/0065146 A1
(43) Pub. Date: Mar. 4, 2021

(54) METHODS OF PROVIDING A USER INTERFACE FOR A HIGHER EDUCATION COMMUNITY, AND RELATED HIGHER EDUCATION DATA NETWORKS

(71) Applicant: Ellucian Company L.P., Malvern, PA (US)

(72) Inventors: Kurt August Zarefoss, Middletown, MD (US); Mary-Anne Blodgett, Herndon, VA (US); Bret Stephen Hansen, Henderson, NV (US)

(21) Appl. No.: 17/005,793

(22) Filed: Aug. 28, 2020

Related U.S. Application Data
(60) Provisional application No. 62/894,133, filed on Aug. 30, 2019.

(51) Int. Cl. G06Q 20/12; G06Q 50/20

(52) U.S. Cl. CPC G06Q 20/123; G06Q 50/205

(57) ABSTRACT

A method of providing a user interface for a higher education community is provided. The method includes: (a) providing a user interface for use by each of a plurality of members of a higher education community; and (b) customizing the user interface for each of the plurality of members of the higher education community.

### CROSS-REFERENCE TO RELATED APPLICATION

This application claims the benefit of U.S. Provisional Patent Application No. 62/894,133 filed Aug. 30, 2019, the content of which is incorporated herein by reference.

### FIELD

The invention relates to user interfaces for a higher education community, and more particularly, to improved user interfaces that are customized for each of a plurality of members of the higher education community.

### BACKGROUND

In a present day higher education community, students may interact with many distinct software applications to accomplish a few tasks. This leads to a disjointed, impersonal, inconsistent user experience, and higher education institutions have failed to provide students (and other members of their community) with one single, consistent system and method for presenting users with the information and resources they need to be successful members of the community.

Thus, it would be desirable to provide systems and methods for improving interactions within higher education communities.

### SUMMARY

According to an exemplary embodiment of the invention, a method of providing a user interface for a higher education community is provided. The method includes: (a) providing a user interface for use by each of a plurality of members of a higher education community; and (b) customizing the user interface for each of the plurality of members of the higher education community.

According to another exemplary embodiment of the invention, a higher education data network is provided. The higher education data network includes: (a) a user interface for use by each of a plurality of members of a higher education community, the user interface being customized for each of the plurality of members of the higher education community; (b) a plurality of computing devices for use by each of the plurality of members of the higher education community, each of the plurality of computing devices being configured to access the user interface customized for a respective member of the higher education community; and (c) at least one host computing device for managing access and customization of the user interface for each of the plurality of members of the higher education community.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1C are high level block diagram views of higher education user interfaces in accordance with various exemplary embodiments of the invention;

FIG. 2 is a block diagram view of functional components of a higher education user interface in accordance with an exemplary embodiment of the invention;

FIG. 3 is a block diagram view of a card marketplace in accordance with an exemplary embodiment of the invention;

FIG. 4 is a block diagram view of a card generator based on templates in accordance with an exemplary embodiment of the invention;

FIG. 5 is a block diagram functional diagram for card configuration and access control in accordance with an exemplary embodiment of the invention;

FIG. 6 is a block diagram functional diagram for card license management and inclusion in accordance with an exemplary embodiment of the invention;

FIG. 7 is a block diagram functional diagram, including artificial intelligence (AI) and machine learning (ML) aspects, for card recommendation in accordance with an exemplary embodiment of the invention;

FIG. 8 is a block diagram functional diagram illustrating state management for tenant configuration in accordance with an exemplary embodiment of the invention;

FIG. 9 is a flow diagram outlining marketplace interactions in accordance with an exemplary embodiment of the invention;

FIG. 10 is a flow diagram outlining the creation of a card from a supplied template in accordance with an exemplary embodiment of the invention;

FIG. 11 is a flow diagram outlining the configuration of cards for the tenant and user community in accordance with an exemplary embodiment of the invention;

FIG. 12 is a flow diagram outlining the management of procured cards in accordance with an exemplary embodiment of the invention;

FIG. 13 is a flow diagram illustrating user access to a specific dashboard in accordance with an exemplary embodiment of the invention;

FIG. 14 is a flow diagram illustrating user interactions while searching for cards to add to their dashboard in accordance with an exemplary embodiment of the invention;

FIG. 15 is a flow diagram illustrating card creation using a development kit and deployment approval in accordance with an exemplary embodiment of the invention; and

FIGS. 16A-16D are a series of block diagram illustrations of a higher education data network in accordance with an exemplary embodiment of the invention.

### DETAILED DESCRIPTION

In accordance with certain exemplary embodiments of the invention, a single interface is provided where a user can access dynamic data and personalized content aggregated from multiple disparate sources, based on their role and usage patterns—all within a personalized, consumer-grade web application. Such a user interface enables the campus community to act on the data that is most relevant to them regardless of the application source, and focuses on the goals and actions the user needs at the time.

Exemplary user interfaces are centered on a cross-solution home page with tailored content based on the role of the user (i.e., the specific member of the higher education community). A user may start their day utilizing their specific interface. Navigation and tailored home page functions allow a user to log in and visualize their most critical items (e.g., actions required, information provided, etc.) across various software application and content sources. This tailored experience is designed to work with existing software applications, partner content, content built by an institution, etc.

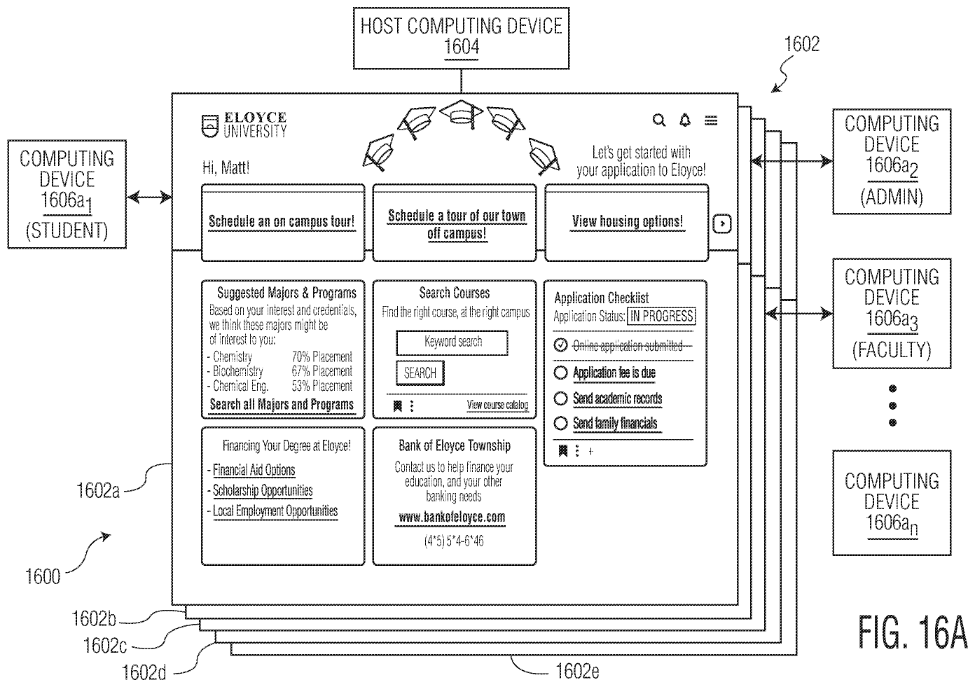

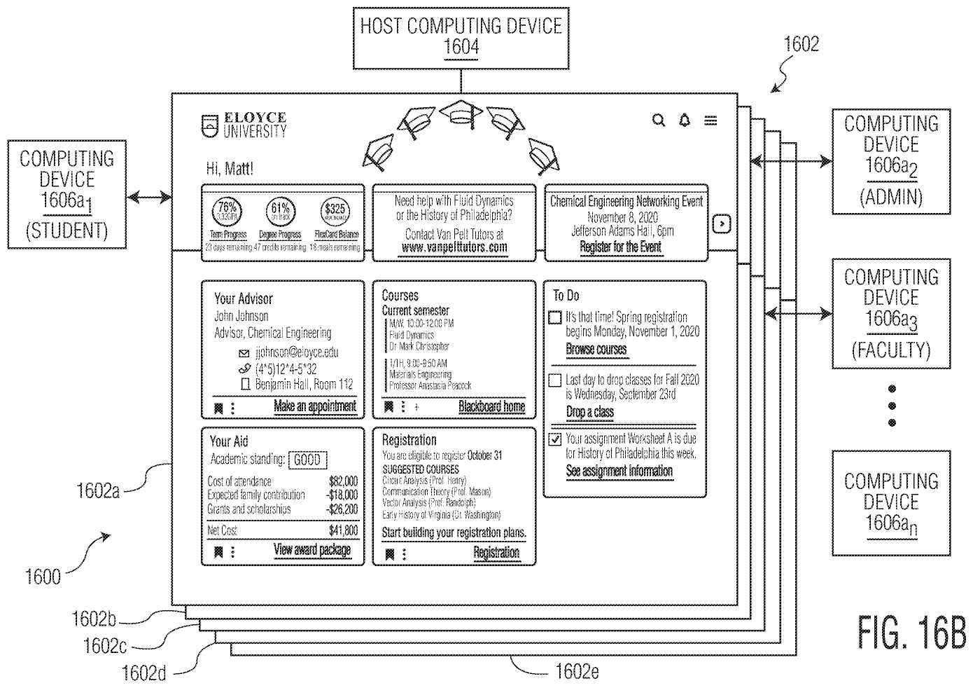

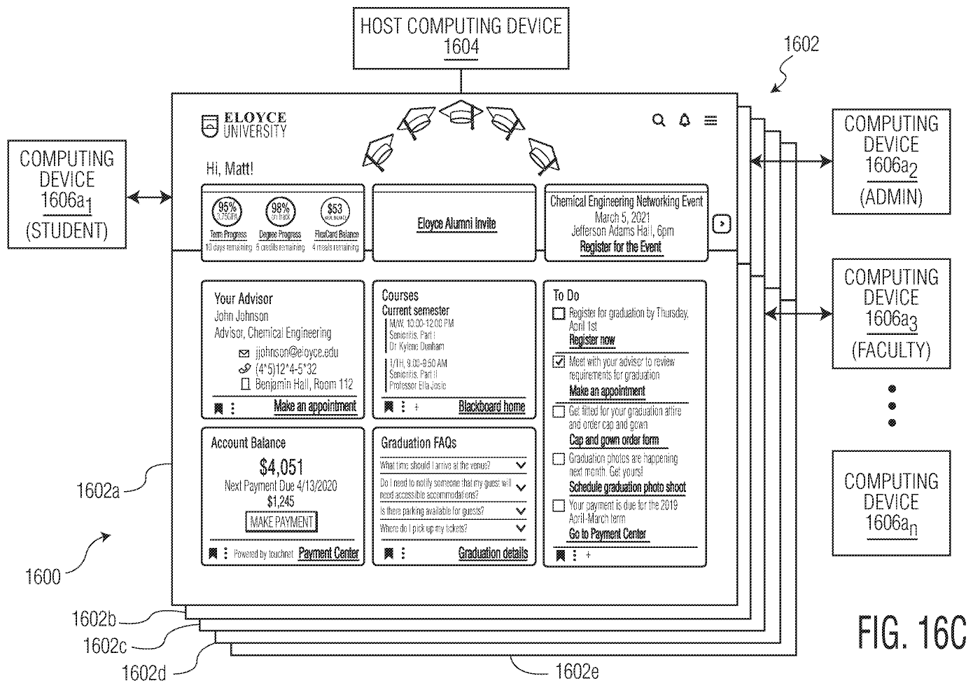

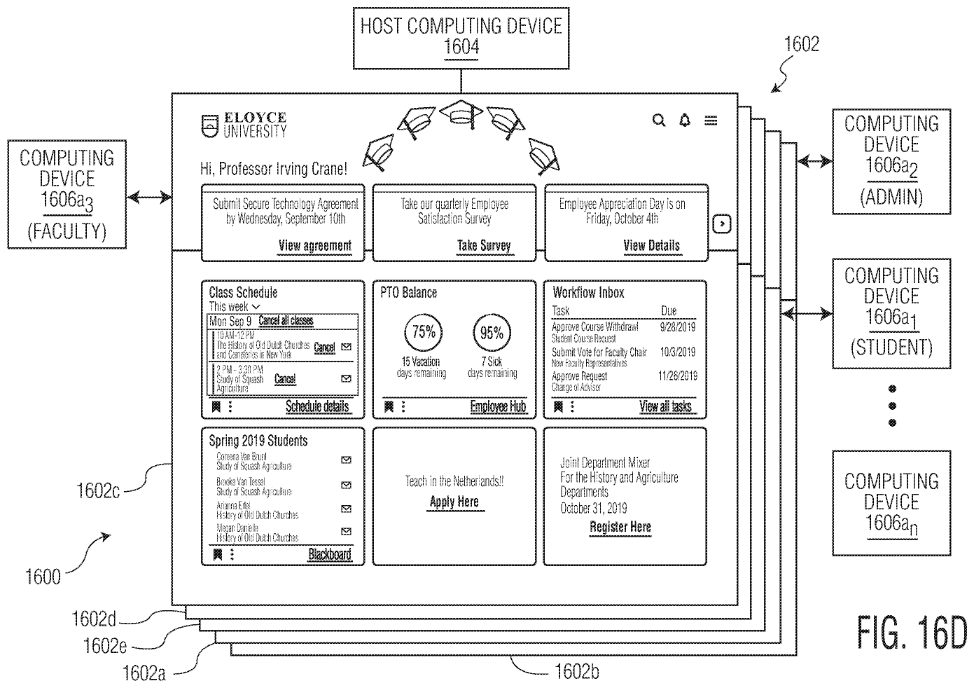

The user (i.e., the specific member of the higher education community such as a student, a faculty/staff member, a member of the university administration, etc.) has a space or view where they can add, remove, re-organize the “cards” that are of most interest/value to them. The user interface (which may be considered a user homepage or dashboard) supports user curated content along with other content (e.g., promotional content, featured content, recommended content, etc.) based on the user's role or other relevant data. That is, the other relevant data (in addition to the user's role) about the user (“data attributes” about the individual) may be exploited in real-time to adjust access to content and functionality on their homepage/dashboard. For example, as a student gets close to graduation (as known automatically by the interface, via the hosting system, based on acquired data), a graduation “ad” or other information may appear on the user's homepage/dashboard (e.g., See FIG. 16C). In another example, if a student is struggling in a particular subject (as known automatically by the interface, via the hosting system, based on acquired data), a tutoring “ad” or other information may appear on the user's homepage/dashboard (e.g., See FIG. 16B). The data used to make those determinations resides in the “hosting system” (e.g., see host computing device 1604 in FIGS. 16A-16D), and is generally not manually managed by an administrator. Rather, it is automatic, as the data changes, the interface changes.

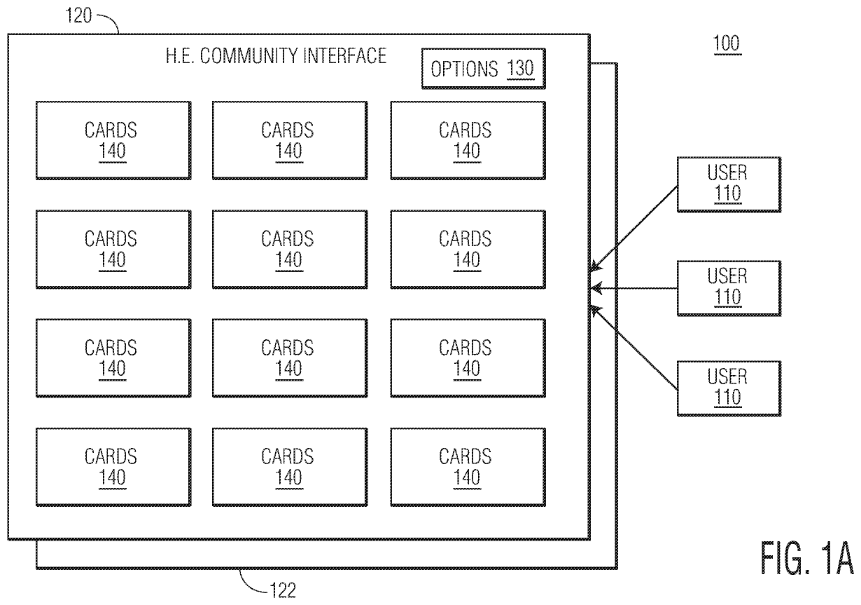

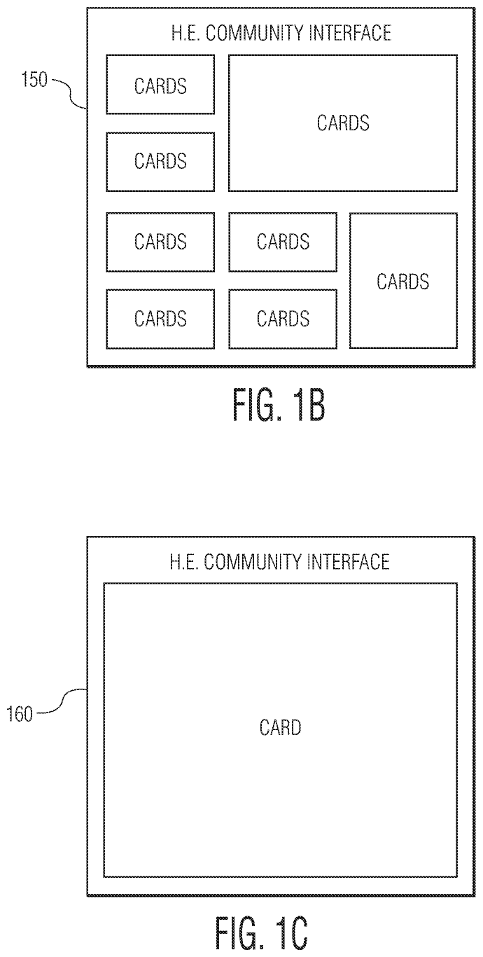

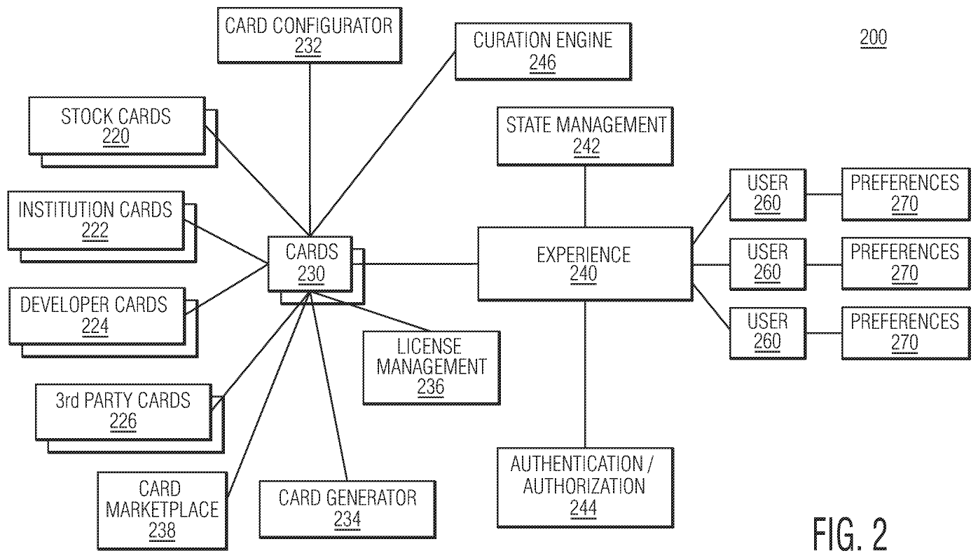

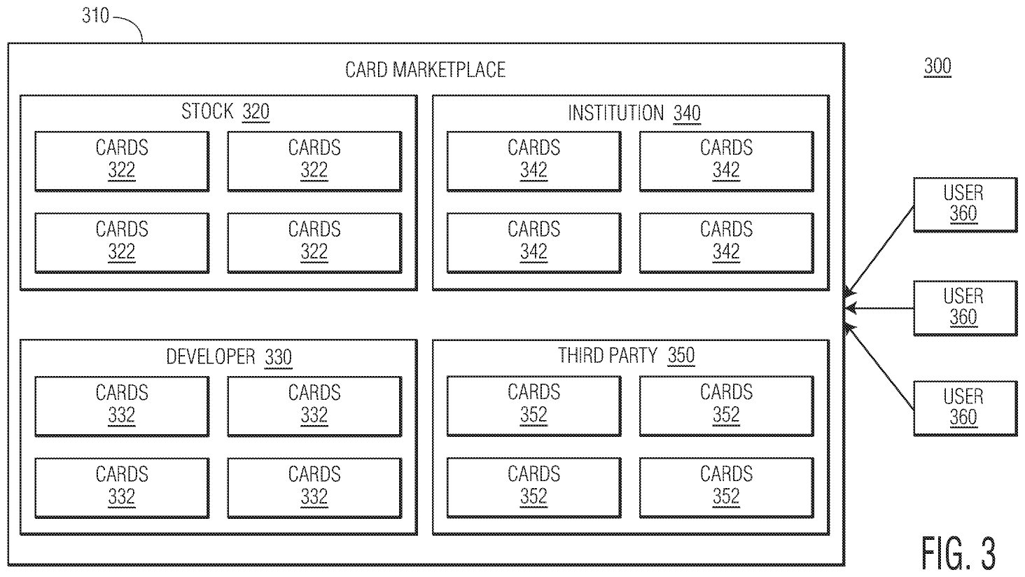

In the drawings provided herein, for ease of illustration and explanation, different reference numbers may be used to refer to the same item or a similar item (e.g., a user, a service, a process, etc.), and as such the various drawings are linked to one another. For example, FIG. 1A illustrates cards 140, and FIG. 2 illustrates cards 230 (and cards 220, 222, 224, 226) and FIG. 3 illustrates cards 322, 332, 342, and 352 (and so on, as cards are shown in others of the drawings as well). Thus, it is understood that the term “cards” as used herein may represent any cards in any of the various drawings interchangeably, and others within the scope of the invention. In another example, FIG. 1A illustrates user 110, FIG. 2 illustrates user 260, FIG. 3 illustrates user 360 (and so on, as users are shown in others of the drawings as well). Thus, it is understood that the term “user” as used herein may represent any user in any of the various drawings interchangeably, and others within the scope of the invention. This concept (of interchangeable numbers) is applicable to many items shown in the drawings having the same name.

FIG. 1 illustrates a user interface 120 (e.g., a collection of user specific dashboards, where each dashboard 122 represents a user's specific experience in connection with a higher education community) (sometimes the interface is referred to herein as “experience”). Interface 120 provides users 110 with a personalized, unified way of interacting with the institution's digital content. Institutions as well as users within the institutions can have specific dashboards 122 relevant to their needs and persona. Interface 120 delivers a single interface where a user can access dynamic data 140 (e.g., in the form of a plurality of cards) and personalized content aggregated from multiple disparate sources, based on their role and usage patterns. Users can manage the content they see in a number of ways including various options 130 such as search and discovery, pushed content and intelligent curation.

The size of the cards, and the view of a user's specific interface, may be altered by the user. FIGS. 1B-1C illustrate variations by a user. Any changes to the sizes of the cards (or other edits) are maintained in State Management such that as a user returns to their dashboard previous changes are retained. The layout of each card is maintained within a grid system, but any card can span one or more rows and/or one or more columns. FIG. 1B illustrates a first view 150 including a plurality of cards, while FIG. 1C illustrates another view 160 where one of the cards from FIG. 1B has been selected and expanded into a full screen view. This is a temporary setting and is not retained if the user leaves the dashboard and returns in a different session. Along with the end user dashboard, aspects of the invention related to a grouping of capabilities to enable partners and clients to create, generate, and share cards across institutions. Cards may be free or paid. Aspects of the invention also relate to capabilities for managing roles and user access (e.g., where 110 relates to a unique, authenticated end user, 120 relates to a web based application providing an interface unique to the authenticated user, 122 illustrates multiple concurrent instances of the application, 130 relates to a utility navigation (“option”) to access controls like search, notifications, menu, and 140 relates to a card which may represent an application and/or a collection of data objects.

FIG. 2 illustrates a next generation platform 200 that supports the aggregation of developer, partner and institution content to users in a consistent, unified and purposeful way. The dashboard 240 (“experience”) is the end users 260 point of interaction to all of the services outlined within FIG. 2. The dashboard surfaces its content into various discrete user interface snippets that are called cards 230. A single user may have zero or more cards showing on their dashboard. Cards encompass many different sources of content including stock cards 220, cards 222 created by institutions, cards 224 created by developer product teams, and cards 226 created by 3rd party partners. Cards are made available to the overall solution based on a licensing management functionality 236 during the acquisition process of the solution, by generating them from templates via the card generator 234 or by acquiring additional cards from the card marketplace 238. Cards that have licensing terms that need to be renewed or cancelled can all be managed via the license management 236 functionality at any time. In addition to specifying cards that are available to the user community within the institution, the institution can setup overall default settings and behaviors for the user community using state management 242. Cards are made available to specific users 260 in a number of ways including security controls managed by the card configurator 232, the curation engine 246 and the overall authentication/authorization service 244. Users can customize aspects of their experience using preferences 270 that are unique to each of their authenticated accounts. This allows for an even more customized experience around content, language, accessibility, lactonization and other data and user interface aspects. In FIG. 2: 220 relates to stock cards (e.g., empty cards with a pre-refined layout (template) that may be populated by an institution, base functionality cards that support functions such as notes, to-dos, tasks, etc.); 222 relates to institution created cards (e.g., cards created by institutions that may be customers of the developer); 224 relates to developer created cards (e.g., cards sourcing data from the developer product portfolio such as Degree Works, Banner, Colleague, CRM Advise, etc.); 226 relates to 3rd party cards (e.g., cards created by partners outside of developer); 230 relates to cards generally (e.g., collection of data objects that may be assigned to different user's dashboard views); 232 relates to a card configurator, where cards are setup and configured for use by the user community; 234 relates to a card generator, where cards may be created based on stock templates with specific content from an institution without writing code/software; 236 relates to license management (e.g., licensing control for cards that cost money or are associated with the purchase of other developer or 3rd party products; 238 relates to a card marketplace (e.g., a marketplace to explore available cards, make purchases and/or publish cards for sale within the marketplace); 240 relates to the interface experience dashboard (e.g., the main dashboard user interface that is unique to each authenticated user); 242 relates to state management (e.g., the state of the dashboard at the institution and user levels); 244 relates to authentication/authorization capabilities (e.g., how to map a defined named user's role(s) to a collection or a defined card element). (this level of authorization is intended to provide a filter and security layer in which a named user will only “see” navigation elements in which they are entitled to see); 246 relates to a curation engine which is an Artificial Intelligence (AI) and Machine Learning (ML) set of services to identify card content for users in order to provide them the most relevant data based on their persona within experience 240 and other unique per user characteristics; 270 relates to preferences which are services (store data unique to each authenticated user), including customizations to the layout of the dashboard, language settings, localization preferences, etc.; and 260 represents a unique, authenticated end user.

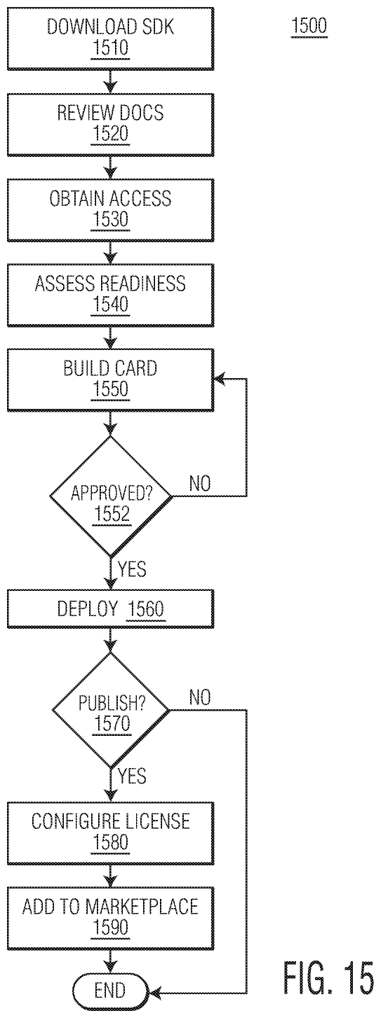

FIG. 3 is a block diagram 300 illustrating a marketplace 310 (which may be considered as an example of marketplace 238 from FIG. 2). Marketplace 310 is where institutions may acquire/purchase additional cards that are being provided by developers 320 and 330, third parties 350 or other institutions 340. Institutions 340 may also publish cards to the marketplace for purchase by other institutions. Cards are managed within various categories including stock cards 322, institution cards 342, developer product cards 332 and third party cards 352. Any combination of cards can be purchased from the marketplace at any time as long as the institution is an active license holder of interface/experience product. Institutions that publish cards for sale in the marketplace 342 may revoke them at any time. There is no refund of any purchase cost by other institutions when this occurs. The cards that are published are capabilities only and do not contain data from the source institution. Cards that are published by institutions may go through a review process before being made available for sale and could be returned to the publishing institution for corrective action (See FIG. 15 for a specific example process). A variety of revenue sharing capabilities will be managed by the marketplace in addition to the license management service (e.g., see FIG. 2, element 236). In FIG. 3: 310 relates to a card marketplace; 320 relates to a stock card market; 322 relates to a stock card (e.g., empty cards with a pre-refined layout (template) that may be populated by an institution, base functionality cards that support functions such as notes, to-dos, tasks, etc., which are cards that may be free or come at an additional cost); 330 relates to the developer market; 332 relates to the developer cards (e.g., high-value dynamic cards for most higher education institutions—where examples may include financial aid content, my advisor, paid time off (PTO) and course assignments, and grades, where such cards may be free or come at an additional cost); 340 relates to an institution market; 342 relates to institution cards (e.g., these cards may be free or come at an additional cost); 350 relates to a third party market; 352 relates to third party cards (e.g., these cards may be free or come at an additional cost); 360 relates to a unique, authenticated end user with permissions required to make purchase from the marketplace.

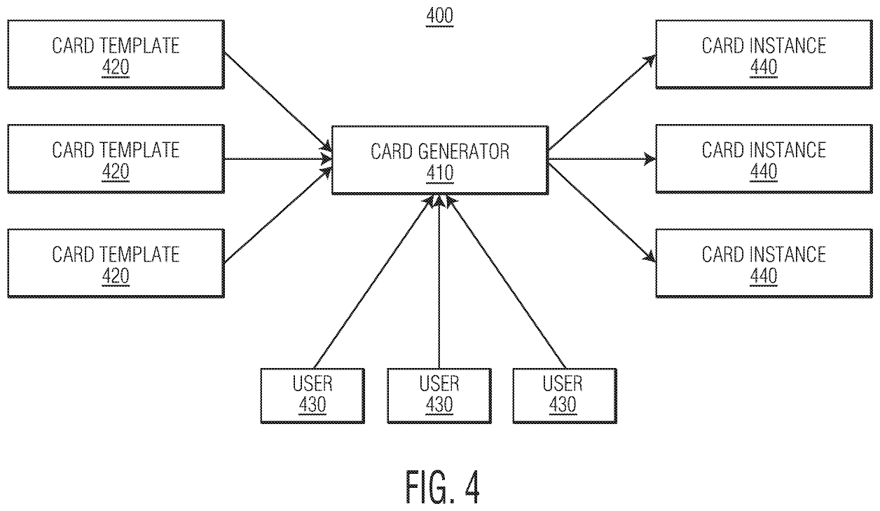

FIG. 4 is a block diagram 400 illustrating a card generator 410. Card generator 410 enables users 430 with proper permissions to create and manage cards 440 based on supplied templates 420. Each card can be created, customized and deployed separately and should have its own lifecycle. This allows cards to be added, modified and removed independent of the platform system. In FIG. 4: 410 relates to a card generator; 420 relates to a card template (e.g., a card with no data but a defined layout to be populated by the user); 430 relates to a unique, authenticated end user; 440 relates to a card instance (e.g., a card template merged with content specified by the institution/user).

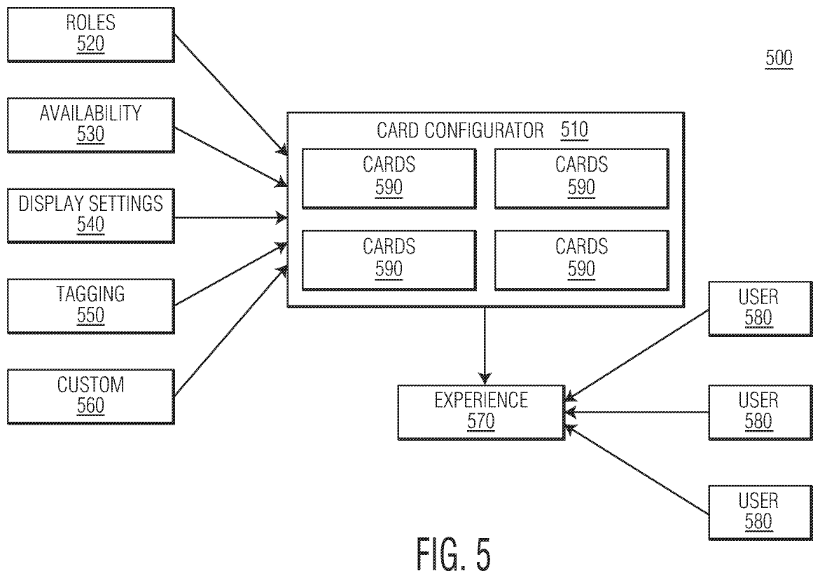

FIG. 5 is a block diagram 500 illustrating a card configurator 510. Card configurator 510 allows authenticated and authorized users 580 with administrative permissions to change various attributes about the cards 590 they have licensed. There are many attributes that can be manipulated via the card configurator. Some settings will be based on the card type, source and/or template from which they are based, and in all cases these settings could change over time. For access control, roles 520 may be used. As opposed to the role of the user (or in addition to the role of the user), access to cards/pages and other content, as well as real time updating of content on a card/page, may be controlled using additional data in the underlying system (as provided above, other relevant data about the user (“data attributes” about the individual) may be exploited in real-time to adjust access to content and functionality on their homepage/dashboard).

A system administrator user 580 can create any number of roles within the interface/experience. These roles can then be assigned to users which would allow those users to discover and utilize those cards on their dashboard. For the purposes of changing the configuration of a card, it may be necessary to make cards unavailable from end users for a period of time. The availability 530 setting provides the mechanism to remove a card from end user dashboards without changing its licensing status. Many cards will have various display settings 540 that can be applied by an administrator. For example, graphically oriented cards may be able to show a progress indicator, a pie chart, a line graph or a bar chart. To help categorize cards into various types for discovery an administrator can assign tags using the tagging 550 setting to the cards to help classify them. For example, tags such as “student”, “freshman”, “advisor”, etc. can be applied to a card. Zero or more tags may be added to a card and the overall vocabulary of possible tags is also managed for consistency. To assist in facilitating special needs of cards created by partners, third parties or application teams a “custom” configurator facility (e.g., using custom 560 setting/facility) is made available to capture card specific settings that can be applied. In FIG. 5: 510 relates to a card configurator; 520 relates to roles (e.g., roles 520 that have been created within the system to manage authorization to view cards, roles are assigned to both users 580 and cards 590 to enable usage); 530 relates to availability (e.g., sets if the card accessible (Boolean) by the user 580 community); 540 relates to display settings (e.g., specific settings that may vary by card 590 and would apply to all users); 550 relates to tagging (e.g., administrative users can manage a set of tagging 550 terms to help categorize cards 590—zero or more tags can be applied to cards 590 to make them easy to discover and manage; 560 relates to custom (e.g., a facility to allow for custom configurations that fall outside the others already mentioned that could vary by card 590); 570 relates to a developer experience dashboard; 580 relates to a unique, authenticated end user (e.g., could be an end user of experience, could be an administrative user of experience).

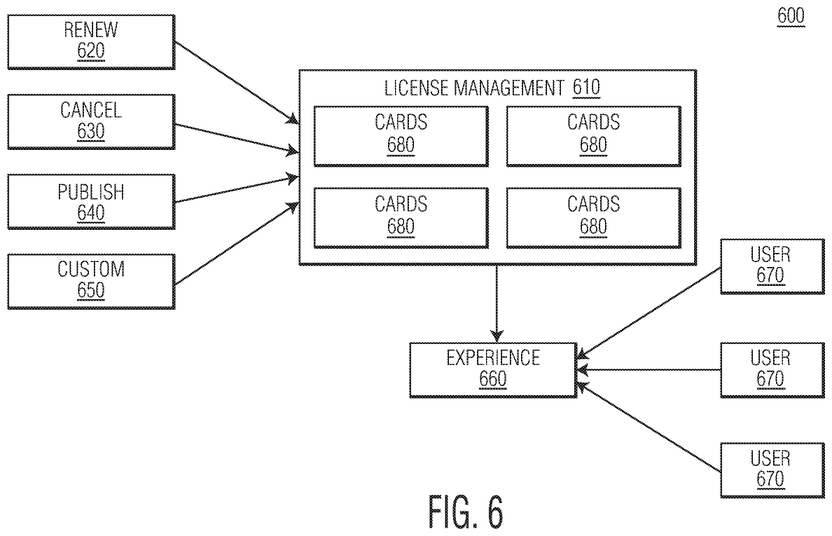

FIG. 6 is a block diagram 600 illustrating a license management 610 facility. License management 610 facility allows authorized and authenticated users 670 the ability to manage which cards 680 are available for use within experience 660. Cards that may expire and need to be renewed will be flagged, appropriate administration users 670 may be alerted, and a facility for renewal 620 in a manual or automated fashion is provided. Cards that an administrative user may want to remove from the system permanently can be cancelled 630 using the license management service. Cards that an institution want to make available to the marketplace can go through a publishing 640 and approval processes. Cards that have been published can be revoked by the publishing institution at any time. Additionally, developer can revoke published cards at any time. Cards that need to surface or support any custom 650 data or capabilities around managing its licensing and availability within experience 660 are managed here. In FIG. 6: 610 relates to license management; 620 relates to renewing (e.g., the ability to renew a license for a card(s) 680 that may be expiring); 630 relates to cancellation (e.g., canceling a current subscription to a card 680 that is no longer required); 640 relates to publication (e.g., the process of making a card available to other institutions that are licensed to use experience); 650 relates to custom settings (e.g., a mechanism to surface any unique or custom licensing data or capabilities for different card types); 660 relates to the experience dashboard; 670 relates to a unique, authenticated end user (e.g., an administrative user of experience); and 680 relates to cards.

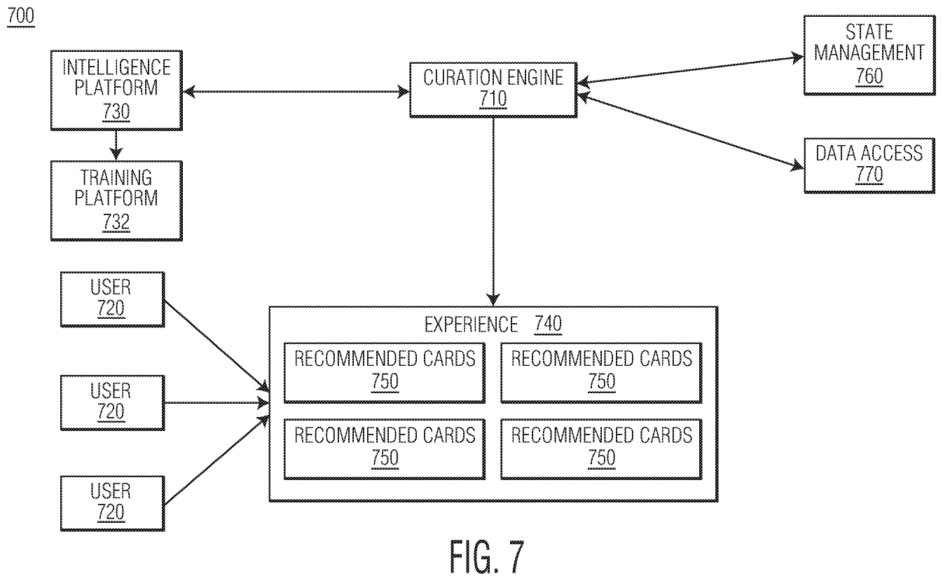

FIG. 7 is a block diagram 700 illustrating a curation engine 710. Curation engine 710 is an Artificial Intelligence (AI) and Machine Learning (ML) service powering a recommendation engine for interface/experience 740. Data from multiple sources including (but not limited too) the user 720 persona, other like users within the institution using experience 740, data about the user and other users within the system 770, degree progression 770, the configuration of experience across the institution (via state management 760) and other aggregate data sources in data access 770 are brought together. The data is then used to train various algorithms 732 to determine a best fit model. This model is then exposed via a set of services within the intelligence platform 730 to allow experience 740 to make card recommendations 750 to each user 720 based on their current usage patterns and characteristics similar to other users. In FIG. 7: 710 relates to curation engine (e.g., a service that uses the intelligence platform 730 to determine cards 750 that could be of interest to each specific user 720 based on usage patterns (where data from data access 770 and the experience state management 760 are combined with other data to surface recommended cards 750); 720 relates to a unique, authenticated end user; 730 relates to an intelligence platform (e.g., a set of artificial intelligence (AI) and machine learning (ML) services that create a recommendation engine based on Experience 740 user patterns and user personas); 732 relates to a training platform (e.g., the data and tools used to train the recommendation engine to identify cards that may be of interest to a user based on usage patterns from other users within the same or different institutions); 740 relates to a developer experience dashboard; 750 relates to recommended cards (e.g., cards that have been marked as being of interest to specific users 720 of experience for addition to their dashboard); 760 relates to state management; 770 relates to data access (e.g., a data cache of ethos related information and other external data that can be used to help match users 720 to cards 750 that may be of interest).

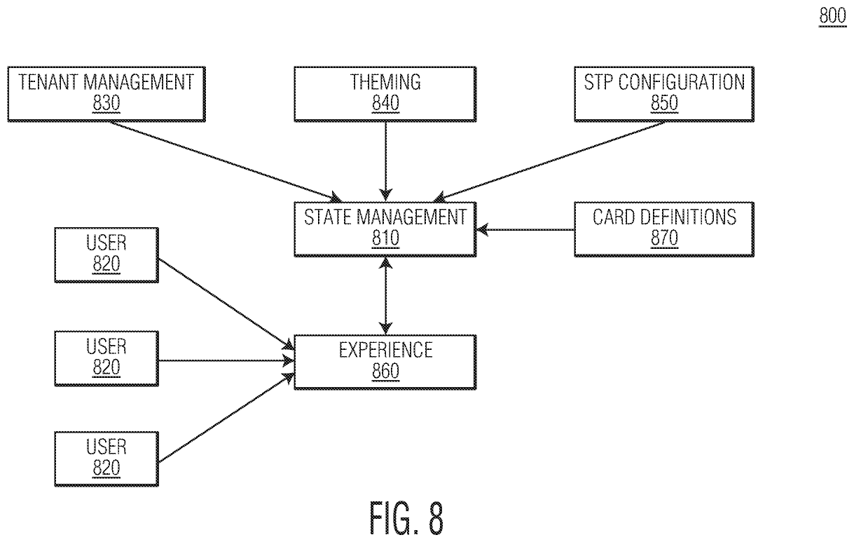

FIG. 8 is a block diagram illustrating state management 810 (which may be an example of, and similar to, state management 760 in FIG. 7). Most systems require state to be managed in order to provide a consistent and predictable experience for the user community. Interface/experience 860 is not different in this regard. However, with data being available to experience from multiple sources, the system is able to offer unique capabilities such as a recommendation engine, multi-tenant support 830, a marketplace, institution specific configurations 840 (i.e., theming 840) and shared technology platform (STP) configuration 850 support. When experience is purchased/licensed by an institution a minimum of two instance are provisioned. These instances allow the institution to try various configurations and settings in a test environment and then publish those changes to production after user acceptance testing. Each institution is sharing certain aspects of the solution while maintaining data and user 820 segregation. This is all supported and enforced by tenant management 830. As cards are purchased, configured and made available to users these card definitions 870 (i.e., configuration settings) are all stored by tenant within state management 810. Additionally, all user 820 configuration and settings for each user's dashboard are also stored as part of state management. Each tenant may have themes 840 applied to provide a unique institution look and feel to the solution allowing schools to preserve their style and identity to the user community. Themes can be changed at any time by authenticated and authorized users 820 and re-used since each theme can be stored as part of the state management 810. So cyclical settings for enrollment, new freshman classes, holidays, sporting events, etc. can be quickly referenced and applied. For groups of institutions that are affiliated and are sharing an instance of experience, it can be setup in such a way using the STP configuration 850 that some data can be shared, and other data can be segregated. Not only does this provide a potential cost savings to the institution but can also allow other functionality to be surfaced in the solution for institution/campus data aggregation for some authorized users 820 that are using specific cards (via card definitions 870) that are STP aware. In FIG. 8: 810 relates to state management (e.g., the developer experience will follow the use and services provided by integration and cloud-based tenant services and provisioning practices); 820 relates to a unique, authenticated end user (e.g., where the user could be an end user of experience, could be an administrative user of experience, etc.); 830 relates to tenant management (e.g., a service to be provided based on multi-tenant cloud services, where each named client will be provisioned a test & production instance); 840 relates to theming (e.g., an administrative function to create a system wide color and/or theming options for a defined tenant, where this function is intended to create a school or university-based view; 850 relates to STP configuration (e.g., support for groups of institutions who share a single database instance for the purposes of student portability across the system/consortium, cost savings, shared business processes, and/or centralized IT administration—some of the data is shared, while other data is secured by institution within data tables); 860 relates to a developer experience dashboard; 870 relates to card definitions (e.g., the configuration of cards as defined by the card configurator, license management and marketplace).

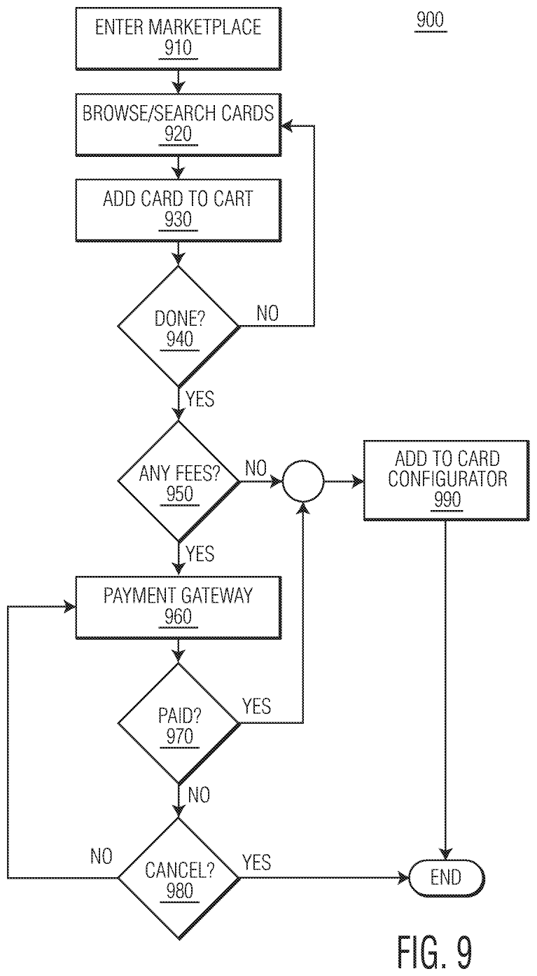

FIG. 9 is a flow diagram 900 illustrating an exemplary marketplace flow. A marketplace is where authorized and authenticated users go to acquire additional cards for use within Experience. Once the marketplace is accessed (at Step 910) the user will be presented with multiple methods of search and discovery including recommendations from the curation engine at Step 920. Each card that is presented in the marketplace could have different licensing mechanisms. Experience will provide flexibility in this area to accommodate changing needs over time as well as different requirements from the card contributors. As cards that are of interest are identified (e.g., that are of interest to the institution), they can be collected for acquisition using a cart metaphor at Step 930. Some cards may be free while others may have a fee associated with them (e.g., a one-time cost, a recurring cost, or other mechanism). Once the user is done looking for cards at Step 940, a total fee amount will be presented at Step 950 (if any), and if there are costs associated the user will make the purchase via the payment gateway at Step 960. The payment gateway will provide a mechanism for essentially unlimited payment mechanisms that can be expanded over time. If there is an error during payment as determined at Step 970, the user can try again, or decide to cancel the purchase all together at Step 980. If payment is successful, the user will be presented with a summary of the purchase along with an appropriate receipt. The cards will also become visible in the configurator 990 and the license manager. This will allow them to become available to the end user community. In FIG. 9: 910 relates to entry into the marketplace (e.g., where authenticated and authorized end users would enter the marketplace); 920 relates to browsing/searching cards (e.g., use multiple mechanisms to identify a card to purchase); 930 relates to adding a card to cart; 940 relates to determining if the card additions are complete; 950 relates to logic for calculating price (e.g., accumulating all the appropriate fees based on the various types and present the user with a total); 960 relates to a payment gateway (e.g., allowing the user to pay for the cost of the cards via a unlimited and constantly enriched set of payment mechanisms); 970 relates to payment confirmation (e.g., if payment was successful, then make cards available to the configurator and to license management, and if payment was not successful allow the user to retry or cancel the order); 980 relates to cancellation logic (e.g., cancel the order and clear the cart); and 990 relates to adding to the card configurator (e.g., adding the acquired card(s) to the configurator and the license manager for addition to the dashboards).

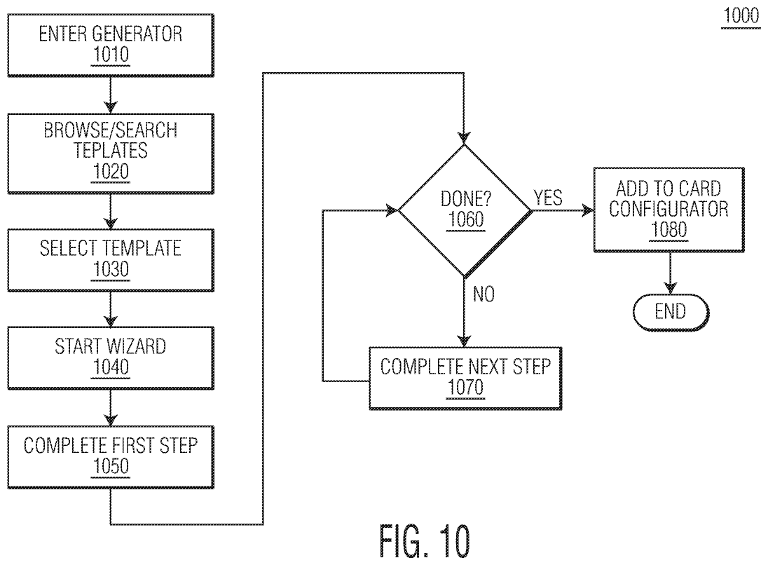

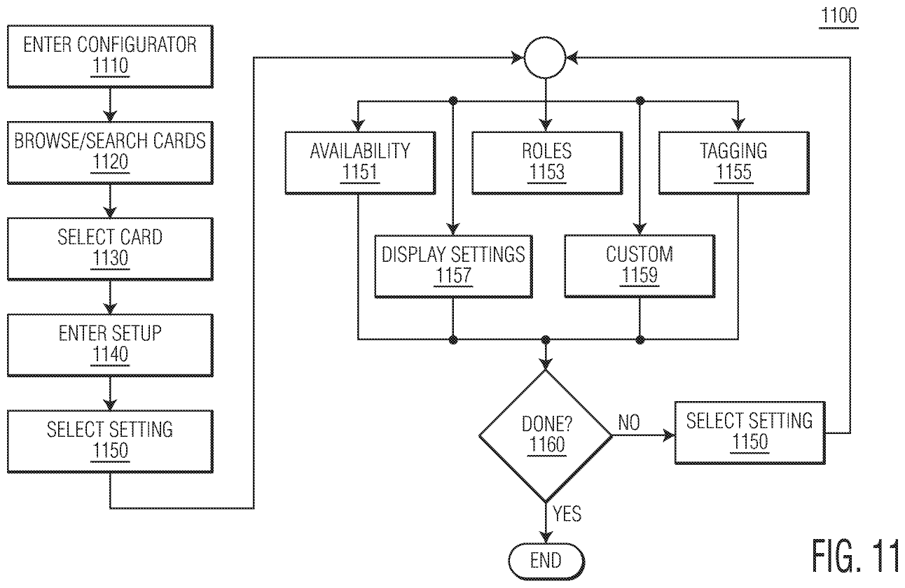

FIG. 10 is a flow diagram 1000 illustrating process flow related to card generation. At Step 1010, a card generator (i.e., a tool that enables authenticated users with the right privileges to create cards requiring no software development for their respective institutions) is accessed. Depending upon the initial template that is selected for content creation the number of total steps required within the generator to complete the task will vary. Once the card generator is accessed at Step 1010 the user is presented with several different search and discovery mechanisms at Step 1020 to identify a base card template to use in creating new content for the dashboards. Once a template is selected At Step 1030 the generator will present the user with a user interface-based wizard at Step 1040 with an appropriate number of steps (beginning at Step 1050) to create the card based on the selected template. The user will complete each step of the wizard in succession (with new steps provided at Step 1070 until all steps are completed as determined at Step 1060) and apply all required information as requested and addressing any errors along the way. Once the user has entered all the required information to construct the card based on the template so that content can be loaded into the card, the card will become visible in the configurator at Step 1080 and the license manager. This will allow them to become available to the end user community. In FIG. 10: 1010 relates to entry into the card generator (e.g., provides the facility by which an authenticated and authorized user can complete the card generation process); 1020 relates to browse/search templates (e.g., use multiple mechanisms to identify a card template); 1030 relates to selection of a template; 1040 relates to starting the wizard (e.g., initiate the wizard process to collect all required information to instantiate a card with the customer's specific data); 1050 relates to completing first step; 1060 relates to a determination whether the card creation is complete; 1070 relates to completion of the next step (e.g., continue to complete each step of the wizard until all are successfully completed); 1080 relates to adding to the card configurator (e.g., adding the acquired card(s) to the configurator and the license manager for addition to the dashboards).

FIG. 11 relates to a flow diagram 1100 illustrating flow related to the card configurator. The configurator allows an authenticated and authorized user to change various properties and attributes for each of the cards they have licensed and are available in the configurable. Once the configurator is accessed at Step 1110 the user is presented with several different search and discovery mechanisms at Step 1120 to identify a card to update. Once the card has been selected at Step 1130, set-up is entered at Step 1140, and the user will be presented with zero or more settings at Step 1150 that support a variety of customizations, security, availability and display attributes. The user may select each available setting at Step 1150 as necessary to have current configurations presented to them via a user interface so that changes can be made. From this primary settings area the user may begin the process of making specific configuration changes in each area. The availability of the card can be turn on and off at Step 1151. This removes it from the dashboards it is current assigned too and hides it from search and discovery functionality until it is turn back on. This setting can also be manipulated by the licensing manager if the license for the card expires and then is renewed. The roles that are assigned to card may also be changed at Step 1153. This could include the addition of new roles or the removal of current roles. If new roles are assigned, then users associated with that new role will now be able to discover that card or have it recommended to them. If a role is removed, it will be removed from all user dashboard where that user no longer has valid access. The tags assigned to a card may also be changed at Step 1155. This could include the addition of new tags or the removal of current tags. If new tags are assigned, then users will be able to discover or search for the card with that new tag. If a tag is removed, it will no longer be discoverable with that tag. The display settings for a card may also be changed at Step 1157. Each card may have different display settings and therefore this screen will vary in look as well as functionality based on the selected card. The custom settings area is reserved for unique attributes that can be manipulated for a particular card at Step 1159. This could be required when institutions or third-party partners define new cards for experience that fall outside the normal patterns and templates we had identified in the base product. It is a means for extensibility. Users can continue to make selections at Step 1150 and change settings until they are finished at Step 1160 at which point, they can commit those changes and make them available to the user community. In FIG. 11: 1110 relates to entry to the configurator (e.g., provides the facility by which an authenticated and authorized user can change card settings); 1120 relates to browsing/searching cards (e.g., using multiple mechanisms to identify a card to update); 1130 relates to cards selection; 1140 relates to setup entry (e.g., initiate the configuration process to allow the user to navigate between all possible configuration settings to make changes); 1150 relates to setting selection; 1151 relates to availability (e.g., change the availability of the card for dashboard inclusion); 1153 relates to roles (e.g., change what roles have access to the card); 1155 relates to tagging (e.g., change what tags are associated to the card for discovery and search); 1157 relates to display settings (e.g., change specific display settings based on the underlying card and card template); 1159 relates to customization (e.g., change any “custom” settings unique to this card); 1160 relates to finalization and saving.

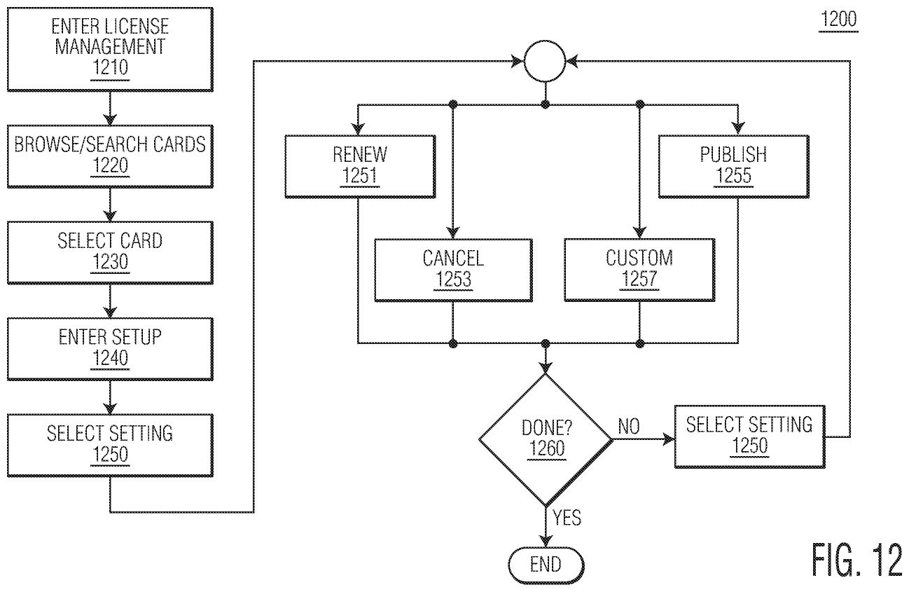

FIG. 12 is a flow diagram 1200 related to license management flow. The license manager allows an authenticated and authorized user to change licensing of cards that are available to the institution. Once the license manager is accessed at Step 1210 the user is presented with several different search and discovery mechanisms at Step 1220 to identify a card to update. Once the card has been selected at Step 1230, set-up is entered at Step 1240, and the user will be presented with zero or more settings and/or actions depending on the card and how it is licensed to the institution. The user may select each available setting/action at Step 1250 as necessary to have current licensing information presented to them via a user interface so that changes can be made. From this primary settings area the user may begin the process of making specific changes in each area. At Step 1251, the renew action allows the user to renew the license of a card that has expired. This could be due to the end of a term or perhaps the auto renewal payment process failed for some reason. Once this action is taken, any required payment process will occur and once successful will renew the license of the card. At Step 1253, the cancel action allows the user to cancel the license of a current card. This would remove it from the license manager and the configurator as well as all end user dashboards currently using the card. Any financial refund that is due would be created as appropriate. The institution can choose to renew the card license at any time in the future. At Step 1255, the publish action allows an institution to initiate a review process that would make available a custom coded card available for sale in the card marketplace. Additional information around licensing and cost requirements and other details will be collected as needed as part of the approval process. If approved, the card would become immediately available, if rejected a notification will be sent to the requester. At Step 1257, the custom settings area is reserved for unique attributes around licensing that could be manipulated for a particular card. This could be required when institutions or third-party partners define new cards for experience that fall outside the normal patterns and templates we had identified in the base product. It is a means for extensibility. Users can continue to make selections at Step 1250 and change settings until they are done at Step 1260 at which point, they can commit those changes. In FIG. 12: 1210 relates to entry into license management (e.g., provides the facility by which an authenticated and authorized user can change card settings); 1220 relates to browsing/searching cards (e.g., use multiple mechanisms to identify a card to update); 1230 relates to card selection; 1240 relates to setup entry (e.g., initiate the license management process to allow the user to navigate between all possible configuration settings and actions to make changes); 1250 relates to setting selection; 1253 relates to cancellation; 1255 relates to publication; 1257 relates to customization (e.g., change any “custom” settings unique to this card); and 1260 relates to finalization and saving.

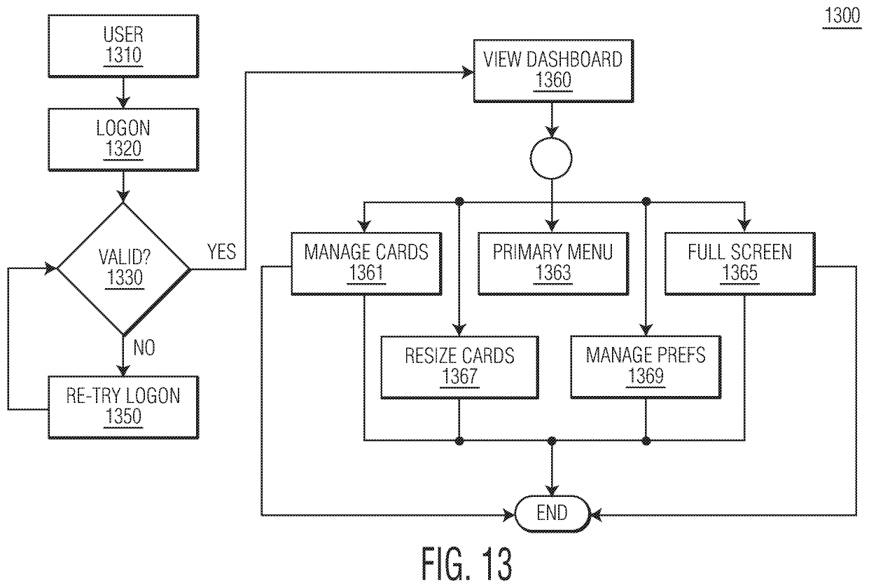

FIG. 13 is a flow diagram 1300 illustrating user persona flow. There are endless ways in which an end user can interact with experience. This flow outlines a few of them. Upon first access at Step 1310, the user is presented with a logon interface at Step 1320 to authenticate. If the attempt is not valid (as determined at Step 1330), the user may retry at Step 1350. If not success the user may abort or go through the underlying identity providers forgot password path which can vary by institution. When the logon is validated the user is presented with the dashboard at Step 1360. There are four main categories of interaction a user can perform. A user can manage the cards at Step 1361 that are visible on the dashboard page. This includes using services like search or the curation engine to identify new content and add that content to the dashboard. The user can also remove cards from the dashboard that are no longer relevant and rearrange where cards are located. A user can resize cards at Step 1367 in order to expose the most relevant data at a glance. Users that need to interact more closely with a card can also make that card full screen at Step 1365 for a period of time. This will overlay the card above all other cards until the user returns it to its configured size. A user can also interact with their preference settings at Step 1369 that allow them to configure other aspects of the dashboard and related cards. For example, date formats, number formats, language selection, display name, etc. could all be changed from this function. The primary menu of the dashboard provided at Step 1363 provides other navigation options that can also be configured for the user allowing them to navigate to other solutions supported by the institution. If the authenticated user is assigned administrative privileges to experience then access to these capabilities would also be provided here. In FIG. 13: 1310 relates to a access by a unique, authenticated end user; 1320 relates to logon (e.g., user logs in using the institution's identity provider login); 1330 relates to valid login logic; 1350 relates to re-trying the logon; 1360 relates to viewing the dashboard; 1361 relates to card management (e.g., the ability to add or remove cards via various discovery methods, the ability to rearrange cards within the dashboard); 1363 relates to a primary menu (e.g., location where user can navigate to other accessible areas of experience in the event they are an administrator, links to other institution support solutions for which the authenticated user has access); 1365 relates to a full screen (e.g., provides a mechanism for a user to expand a card into full screen mode); 1367 relates to resizing of cards (e.g., allows the user to resize cards to more appropriate sizes based on their needs); and 1369 relates to preference management (e.g., allows the user to change various preferences settings for experience such as language, date format, number format, etc.).

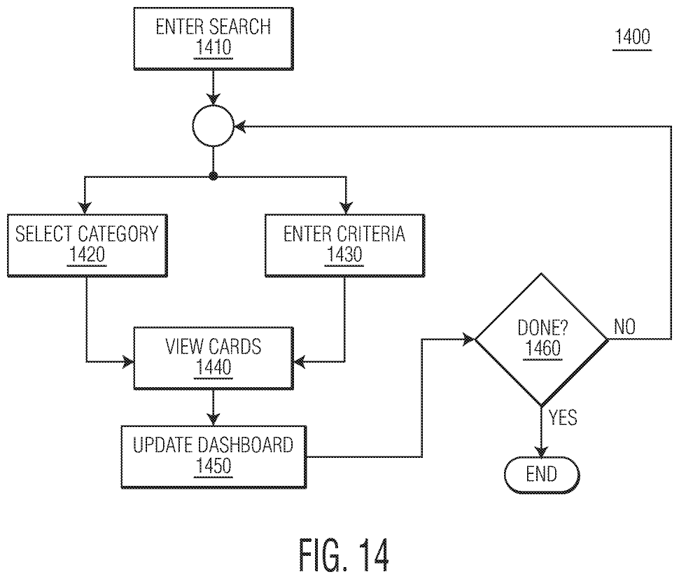

FIG. 14 is a flow diagram 1400 illustrating a search flow. The experience search capability facilitates how cards are discovered through the application. This includes end users that are searching for a card to add to their customized dashboard, to purchase in the marketplace, to configure or to manage licenses. Since this capability is exposed in many different ways, only one particular way will be illustrated but most are applicable system wide. We will focus on an end user persona that has already authenticated and is currently viewing their dashboard. They decide to search for other possible cards to add. Once the user initiates the search functionality at Step 1410, they are presented with a user interface that not only allows for free text input but also shows various categories of cards. These categories are based on the tags that have been associated to the cards by the administrators. In addition, a dynamic category of recommendations will also be shown that uses the curation engine to identify relevant cards for this particular user. The user can utilize both the category facets at Step 1420, and free text search criteria at Step 1430, in order to obtain a list/view of available cards that meet that criteria at Step 1440. Further refinements may be made at any time, causing the number of cards being displayed to increase or decrease. When matched cards are displayed the user may select to have them added to their dashboard at Step 1450 for future use. This change is persisted in state management. This entire process may continue until the user is done (as determined at Step 1460) interacting with the search functionality and closes this portion of the user interface. In FIG. 14: 1410 relates to search entry (e.g., initiate the search functionality); 1420 relates to category selection (e.g., select one or more categories from which to view available cards, this may be used in conjunction with search criteria); 1430 relates to criteria entry (e.g., enter words and/or phrases to search cards based on additional values such as name, description, authoring third party or institution, etc.); 1440 relates to viewing cards (e.g., view the results of the search request and refine the search as needed); 1450 relates to updating the dashboard (e.g., select cards as desired to add them to the dashboard); and 1460 relates to ending the search.

FIG. 15 is a flow diagram 1500 related to card creation and publication flow. Experience provides significant capabilities out of box, along with pre-built cards supplied by the developer, the ability to create new cards via the card generator and a large third-party partner community. However, in the event that a specific card needs to be created by the institution experience also allows for cards to be created from scratch using a software development kit (SDK). These cards can then be deployed into the experience ecosystem and, if desired, shared with other institutions in the experience marketplace. Authorized users can download the SDK at Step 1510 from the experience website. This will provide necessary documentation, training materials, source code examples and libraries needed to develop a custom card. Upon downloading the SDK, the institution development team should review the documentation at Step 1520 provided to understand the patterns, limits, deployment methodologies, review process and other dependencies in order to develop a card. Once the institution is ready to begin development, they will need to request access to the code repository at Step 1530 where their developed assets are managed, provisioned a sand box for testing and given access to internal developer tools to coordinate activities. Once they have reviewed all the materials and have designed their card based on their needs, they need to assess readiness of any developer dependent components to ensure their efforts will be successful at Step 1540. If there are functional gaps in the SDK, APIs, data model or other aspects of the overall solution, appropriate coordinate with developer needs to take place. The next steps involve the actual development of the code that realizes their card capabilities at Step 1550. This involves working with the developer along the way as needed via the tools for which they have been provided access. Once they believe the card is complete and has been tested by the institution development team, and request is made through experience to review the card and grand approval (as determined at Step 1552) for deployment. If the Card is denied, then development work would continue at Step 1550 and the approval process would repeat at Step 1552. If approved, then the card would be deployed at Step 1560 and made available to the institution via the license manager. Once the card has been deployed, at any time thereafter an institution may decide to publish the card into the marketplace at Step 1570 to allow other customizers to use it. In connection with the publication, at Step the institution will setup terms of license 1580 in order to purchase/use the card and then it will be added to the marketplace at Step 1590 for discovery by other institutions. In FIG. 15: 1510 relates to downloading SDK; 1520 relates to documentation review; 1530 relates to obtaining access (e.g., get access to the tools, environment, software and libraries necessary to author a card); 1540 relates to assessing readiness (e.g., make sure that all dependencies on the institution's development needs are satisfied); 1550 relates to card building (e.g., develop the card and test); 1552 relates to request approval (e.g., the developer will review the card and ensure that all standards, performance SLAs and security requirements have been met, if not approved, then the institution can address the review comments); 1560 relates to card deployment (e.g., since the card has been approved, deploy the institutions card into the Experience environment, make the card available to the institution in the license manager and card configurator); 1570 relates to requesting publication; 1580 relates to license configuration (e.g., if the institution wants to publish card to the marketplace the license terms and other required data needs to be provided by the institution); and 1590 relates to adding the card to the marketplace (e.g., enable the cards availability in the marketplace, the card can be removed from the marketplace at any time).

FIGS. 16A-16D are a series of block diagrams illustrating a higher education data network 1600. Higher education data network 1600 includes a user interface 1602 for use by each of a plurality of members of a higher education community. User interface 1602 includes a plurality of dashboards 1602a, 1602b, 1602c, 1602d, 1602e, etc. As explained below, user interface 1602 is customized for each of the plurality of members (users) of the higher education community (via the respective dashboard). A plurality of computing devices 1606a₁, 1606a₂, 1606a₃, . . . , 1606aₙ, are included in higher education data network 600. Such computing devices may be cellular telephones, tablets, personal computers, laptops, or any other computing device. Each of the computing devices is owned (or used) by one of the plurality of members of the higher education community. Each of the plurality of computing devices is configured to access the user interface 1602—that is, the portion of user interface 1602 that customized for the respective member of the higher education community. A host computing device 1604 (e.g., one or more server computers, or other computing devices, including the relevant data for the members of the higher education community) is provided for managing access and customization of the user interface 1602 for each of the plurality of members of the higher education community.

For simplicity, in the exemplary higher education data network 1600, three users are illustrated. Of course, many (perhaps thousands) of users may be included in the relevant higher education data network, with corresponding user specific portions (e.g., dashboards) of the user interface. In the exemplary higher education data network 1600 shown in FIGS. 16A-16D, a first user (a student) is using computing devices 1606a₁, to access their user specific portion of user interface 1602 (i.e., dashboard 1602a). A second user (an administrator) is using computing devices 1606a₂, to access their user specific portion of user interface 1602 (i.e., dashboard 1602b). A user (a faculty member, such as a professor) is using computing devices 1606a₃, to access their user specific portion of user interface 1602 (i.e., dashboard 1602c).

Referring specifically to FIG. 16A, dashboard 1602a includes a plurality of cards (i.e., digital cards, as described herein) that are useful to, and/or specific to, the user (i.e., an incoming student). Referring specifically to FIG. 16B, dashboard 1602a includes a plurality of cards that are useful to, and/or specific to, the user (i.e., the same student from FIG. 16A, but now well into their degree program). Because the change in the status of the student, and the corresponding data attributes of the student, the cards in dashboard 1602a have changed as compared to FIG. 16A. Referring specifically to FIG. 16C, dashboard 1602a includes a plurality of cards that are useful to, and/or specific to, the user (i.e., the same student from FIGS. 16A-16B, but now close to graduation). Again, because the change in the status of the student, and the corresponding data attributes of the student, the cards in dashboard 1602a have changed as compared to FIG. 16B. Referring specifically to FIG. 16D, dashboard 1602c includes a plurality of cards that are useful to, and/or specific to, the user (i.e., a faculty member). The content of the plurality of cards may be generated automatically (e.g., using data received, and/or accessible to, host computing device 1604) based on information such as: the role of the user (e.g., a student, a university administrator, a faculty member, etc.); and/or additional data about the user (“data attributes” about the individual) in the underlying system.

As shown in FIGS. 16A-16D, the background of user interface 1602 is specific to a university or college (in this example, Eloyce University). As explained above, access rights for modifying portions of the user interface 1602 may be provided to each of the plurality of members depending upon which of a plurality of classes (e.g., a student class, a staff/faculty class, and an administration class) each of the plurality of members falls within.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of providing a user interface for a higher education community, the method comprising the steps of:
(a) providing a user interface for use by each of a plurality of members of a higher education community; and
(b) customizing the user interface for each of the plurality of members of the higher education community.

2. The method of claim 1 wherein a background of the user interface is specific to a university or college.

3. The method of claim 1 wherein access rights for modifying portions of the user interface are provided to each of the plurality of members depending upon which of a plurality of classes each of the plurality of members falls within.

4. The method of claim 3 wherein the plurality of classes include a student class, a staff class, and an administration class.

5. The method of claim 1 wherein the user interface includes a plurality of digital cards, wherein step (b) includes customizing the plurality of digital cards included in the user interface for each of the plurality of members of the higher education community.

6. The method of claim 5 wherein the plurality of digital cards includes a plurality of stock cards, a plurality of institution provided cards, a plurality of developer provided cards, and a plurality of partner provided cards.

7. The method of claim 5 wherein the user interface includes a card marketplace for potential purchase of rights related to ones of the plurality of digital cards.

8. The method of claim 7 wherein a first school in the higher education community is configured to license rights to one of the plurality of digital cards from a second school in the higher education community.

9. The method of claim 5 wherein the user interface includes a card generator for use by the plurality of members of the higher education community for generating ones of the plurality of digital cards.

10. The method of claim 9 wherein the card generator provides access to a plurality of card templates for use by the plurality of members of the higher education community in connection with generating ones of the plurality of digital cards.

11. The method of claim 5 wherein the user interface provides recommendations for ones of the plurality of digital cards to be provided to ones of the plurality of members of the higher education community using (a) data related to each of the plurality of members of the higher education community, and (b) an algorithm using the data.

12. The method of claim 5 wherein ones of the plurality of digital cards are specific to a student included in the plurality of members of the higher education community, and others of the plurality of digital cards represent software applications to be used by the student.

13. The method of claim 1 wherein the user interface includes a search tool for searching for content which may be utilized by ones of the plurality of members to customize the user interface.

14. A higher education data network comprising:
a user interface for use by each of a plurality of members of a higher education community, the user interface being customized for each of the plurality of members of the higher education community;
a plurality of computing devices for use by each of the plurality of members of the higher education community, each of the plurality of computing devices being configured to access the user interface customized for a respective member of the higher education community; and
at least one host computing device for managing access and customization of the user interface for each of the plurality of members of the higher education community.

15. The higher education data network of claim 14 wherein a background of the user interface is specific to a university or college.

16. The higher education data network of claim 14 wherein access rights for modifying portions of the user interface are provided to each of the plurality of members depending upon which of a plurality of classes each of the plurality of members falls within.

17. The higher education data network of claim 16 wherein the plurality of classes include a student class, a staff class, and an administration class.

18. The higher education data network of claim 14 wherein the user interface includes a plurality of digital cards, wherein the plurality of digital cards included in the user interface are customized for each of the plurality of members of the higher education community.

19. The higher education data network of claim 18 wherein the plurality of digital cards includes a plurality of stock cards, a plurality of institution provided cards, a plurality of developer provided cards, and a plurality of partner provided cards.

20. The higher education data network of claim 18 wherein the user interface includes a card marketplace for potential purchase of rights related to ones of the plurality of digital cards.

21. The higher education data network of claim 20 wherein a first school in the higher education community is configured to license rights to one of the plurality of digital cards from a second school in the higher education community.

22. The higher education data network of claim 18 wherein the user interface includes a card generator for use by the plurality of members of the higher education community for generating ones of the plurality of digital cards.

23. The higher education data network of claim 22 wherein the card generator provides access to a plurality of card templates for use the plurality of members of the higher education community in connection with generating ones of the plurality of digital cards.

24. The higher education data network of claim 18 wherein the user interface provides recommendations for ones of the plurality of digital cards to be provided to ones of the plurality of members of the higher education community using (a) data related to each of the plurality of members of the higher education community, and (b) an algorithm using the data.

25. The higher education data network of claim 18 wherein ones of the plurality of digital cards are specific to a student included in the plurality of members of the higher education community, and others of the plurality of digital cards represent software applications to be used by the student.

26. The higher education data network of claim 14 wherein the user interface includes a search tool for searching for content which may be utilized by ones of the plurality of members to customize the user interface.
